(19) United States
(12) Patent Application Publication
(10) Pub. No.: US 2007/0129111 A1
(43) Pub. Date: Jun. 7, 2007

(54) Scheduling apparatus and method in smart antenna system

(75) Inventors: Yong-Seok Kim, Suwon-si (KR); Young-Hoon Kwon, Seongnam-si (KR); Soon-Young Yoon, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/607,930

(22) Filed: Dec. 4, 2006

(30) Foreign Application Priority Data
Dec. 2, 2005 (KR) 2005-0116977

(51) Int. Cl. H04B 1/00; H04M 1/00

(52) U.S. Cl. 455/562.1; 455/63.4

(57) ABSTRACT

A scheduling apparatus and method in a smart antenna system including a user where an active nulling is to be conducted are provided, in which at least one user is selected where a normal beamforming is conducted corresponding to a certain criterion; an active nulling user comprising a low channel correlation with the selected beamforming user is selected from users where an active nulling is conducted; and the normal beamforming for the selected beamforming user and the active nulling beamforming for the selected active nulling user are determined. In the system where the normal beamforming user and the active nulling user are mingled, the criterion to select the users that do not interfere with one another is suggested for the same resource to thereby efficiently utilize the resource.

### CROSS-REFERENCE TO RELATED PATENT APPLICATION

This application claims the benefit under 35 U.S.C. § 119(a) of a Korean Patent Application filed in the Korean Intellectual Property Office on Dec. 2, 2005 and assigned Serial No. 2005-116977, the entire disclosure of which is hereby incorporated by reference.

### BACKGROUND OF THE INVENTION

1. Field of the Invention

The present invention relates generally to a scheduling apparatus and method in a smart antenna system. More particularly, the present invention relates to an apparatus and method of efficiently selecting a beamforming user and an active nulling user in a smart antenna system.

2. Description of the Related Art

Performance and capacity of the present-day mobile communication system are fundamentally limited by radio propagation channel characteristics such as co-channel interference signal between cells or within a cell, path loss, multipath fading, signal delay, Doppler spread, and shadowing. Hence, the present-day mobile communication system is implemented by comprehensively managing power control, channel coding, RAKE reception, diversity antenna, cell sectorization, frequency division, and spread spectrum techniques for compensation of the performance and capacity restrictions.

Furthermore, to face the wireless multimedia era, there is rapidly increasing demand for fast transmission of mass data using a radio channel. Additionally, it is a requisite to mitigate an effect of a strong interference signal due to high speed data having a relatively large transmit output and transmit bandwidth in the mixing cell environment where various service signals are mingled, and to support services at hot spots or in shadowing areas. To address performance degradation due to an interference signal and a channel characteristic, a smart antenna technique is considered to be a promising key technology with the most commercial development merit.

FIG. 1 depicts a beam pattern in a general smart antenna system.

As shown in FIG. 1, a beam pattern 111 of a pilot signal in the smart antenna system covers all of cell service area 113 of a base station 100. When a specific terminal 102 resides within the cell service area 113 of the base station 100, the beam pattern 115 of the traffic signal toward the terminal 102 estimates a direction 117 of the terminal 102 and forms the beam in the estimated direction. The beam pattern 115 of the traffic signal can enhance the system performance by reducing a transmit power by virtue of the narrow beam.

However, since the transmission path between the base station 100 and the terminal 102 is wireless, the transmit signal of the base station 100 may arrive at the terminal 102 right away but suffers multipath fading once it reaches the terminal 102 after undergoing reflection, refraction, and scattering against geographical objects nearby. Herein, direction of the terminal 102 and spread in the similar direction are referred to as an Angular Spread (AS) 119.

If the beam pattern 115 of the traffic signal does not cover the entire AS 119, a propagation path of the traffic signal is prone to differ from the propagation path of the pilot signal. That is, a phase of the traffic signal received at the terminal 102 differs from the phase of the pilot signal. As a result, the reception performance drastically degrades when the two phases are different from each other because the phase compensation criterion of the traffic signal is the pilot signal. In other words, the beam pattern 115 of the traffic signal can achieve the maximum system performance when reducing the beam width at most while covering the AS 119 of the terminal 102.

FIG. 2 depicts a configuration of the general smart antenna system.

As shown in FIG. 2, a first base station 200 forms a traffic beam pattern 211 with a first terminal 204 belonging to a cell area of the first base station 200. A second base station 202 forms a traffic beam pattern 213 with a second terminal 206 belonging to a cell area of the second base station 202.

If the first terminal 204 is placed in a handoff area of the two base stations 200 and 202, that is, in a cell boundary area, the first terminal 204 suffers a small signal strength transmitted from the service base station 200 and a greater interference from the adjacent base station 202. Thus, carrier to interference ratio defined in Equation 1 is reduced. Herein, the second terminal 206 undergoes the same influence.

Equation 1 expresses the carrier to interference (C/I) ratio of the terminal.

$$C / {I}_{MS} = \frac{{S}_{sBS}}{{I}_{sBS} + {I}_{nBS 1} + … + {I}_{nBSm} + {N}_{0}} \qquad [ Equation 1 ]$$

In Equation 1, S_{sBS} denotes the signal strength of the service base station, I_{sBS} denotes the interference in the service base station, and I_{nBSm} denotes the interference from the m-th adjacent base station. N₀ denotes the noise.

Disadvantageously, the reception performance of the terminal degrades since the C/I ratio of the terminal lowers because of the interference of the adjacent base stations as defined in Equation 1.

As discussed above, when the C/I ratio of the terminal is low, the service base station can enhance the reception performance of the terminal by requesting an active nulling to the adjacent base station with respect to a relevant user. In this case, each base station accepts a user of the active nulling and a user of the normal beamforming. In other words, when users for the active nulling execution and users for the normal beamforming execution are mingled, a scheduling scheme is required to efficiently select the user.

Accordingly, there is a need for an improved scheduling apparatus and method that eliminates interference of adjacent base stations in a smart antenna system.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a scheduling apparatus and method of enhancing a reception performance of a terminal by eliminating interference of an adjacent base station in a smart antenna system.

Another aspect of exemplary embodiments of the present invention is to provide a scheduling apparatus and method which take count of both users governed by a current base station and users to which an active nulling is requested by an adjacent base station in a smart antenna system.

A further aspect of exemplary embodiments of the present invention is to provide an apparatus and method of selecting a user to be serviced when users of a normal beamforming and users of an active nulling are mingled in a smart antenna system.

The above aspects of exemplary embodiment of the present invention are achieved by providing a transmission method in a smart antenna system, in which, at least one user of a normal beamforming is selected corresponding to corresponding to a certain criterion; an active nulling user having a low channel correlation with the selected beamforming user is selected from users of an active nulling; and the normal beamforming for the selected beamforming user and the active nulling beamforming for the selected active nulling user are determined.

According to one aspect of exemplary embodiments of the present invention, a transmission method in a smart antenna system including a user of an active nulling is to be conducted, in which, a service determined set is constituted by selecting users having a low channel correlation from users of a normal beamforming and users of an active nulling; and the normal beamforming for a beamforming user and the active nulling beamforming for an active nulling user are determined from the users belonging to the service determined set.

According to another aspect of exemplary embodiments of the present invention, a base station in a smart antenna system includes a user selector which selects at least one user of a normal beamforming corresponding to a certain criterion, and selects an active nulling user having a low channel correlation with the selected beamforming user from users of an active nulling; a beam coefficient generator which generates beam coefficients for the selected beamforming user and the selected active nulling user; and a multiplier which forms a beam by multiplying the beam coefficients from the beam coefficient generator by corresponding user signals.

According to a further aspect of exemplary embodiments of the present invention, a base station in a smart antenna system includes a user selector which forms a service determined set by selecting users having a lower channel correlation from users of a normal beamforming and users of an active nulling; a beam coefficient generator which generates beam coefficients for users belonging to the service determined set; and a multiplier which forms a beam by multiplying the beam coefficients from the beam coefficient generator by corresponding user signals.

### BRIEF DESCRIPTION OF THE DRAWINGS

The above and other objects, features and advantages of certain exemplary embodiments of the present invention will be more apparent from the following detailed description when taken in conjunction with the accompanying drawings, in which:

FIG. 1 illustrates a beam pattern of a general smart antenna system;

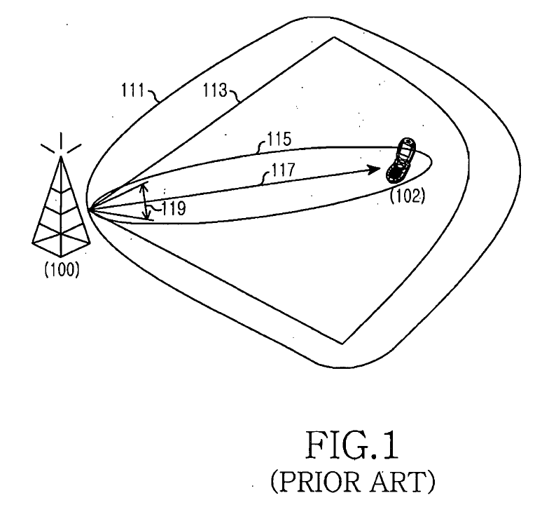

FIG. 2 illustrates a configuration of the general smart antenna system;

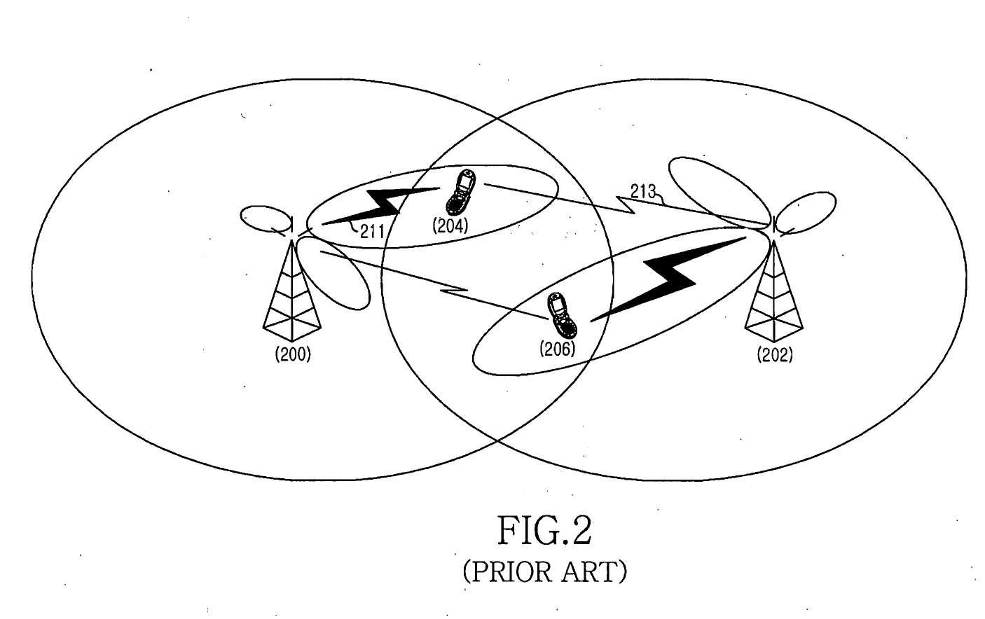

FIG. 3 illustrates a scheduling procedure of a base station in a smart antenna system according to an exemplary embodiment of the present invention;

FIG. 4 illustrates a scheduling procedure of the base station in the smart antenna system according to an exemplary embodiment of the present invention; and

FIG. 5 is a block diagram of the base station in the smart antenna system according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well known functions and constructions are omitted for clarity and conciseness.

Exemplary embodiments of the present invention provide a scheduling technique to enhance a reception performance of a terminal by eliminating interference of an adjacent base station in a smart antenna system. For example, the exemplary embodiments of the present invention provide a scheduling technique which takes account of both a user serviced by a current base station and a user for which an active nulling is requested from an adjacent base station in the smart antenna system.

In general, the active nulling scheme is used to enhance a reception performance of a terminal placed in a cell boundary. In detail, a serving base station estimates a channel of each terminal and performs the beamforming using the estimated channels. In doing so, the serving base station determines whether to execute the active nulling to the terminal by applying the uplink signal strength and the downlink Carrier to Interference ratio (C/I) of each terminal to Equation 2 as below.

Equation 2 is a mathematical expression to determine whether to perform the active nulling for each terminal.
ƒ(C/I_{MS}, P_{UL})Δ[C/I_{MS}<C/I_{threshold}]|[P_{UL}<P_{threhold}] [Equation 2]

In Equation 2, ƒ(A, B)Δ[A][B] denotes a function which determines when one of [A] and [B] conditions is satisfied, C/I_{MS} denotes the C/I of the terminal, and P_{UL} denotes the strength of the uplink received signal of the terminal. C/I_{threshold} and P_{threshold} denote a threshold of the C/I of the terminal and a threshold of the uplink received signal strength.

Herein, when Equation 2 is satisfied, the active nulling is requested of the adjacent base station with respect to a terminal of the adjacent base station which interferes with the terminal.

Below, the exemplary embodiments of the present invention describe a scheduling technique which efficiently selects a user to be serviced in a system enhancing a reception performance of a terminal, that is, in a system where a user for the active nulling execution and a user for the normal beamforming execution are mingled, by eliminating the interference of an adjacent base station through the active nulling scheme. Although Proportional Fairness (PF) scheduling algorithm is exemplified in the following explanation, Round Robin scheme or any other algorithms can be adopted.

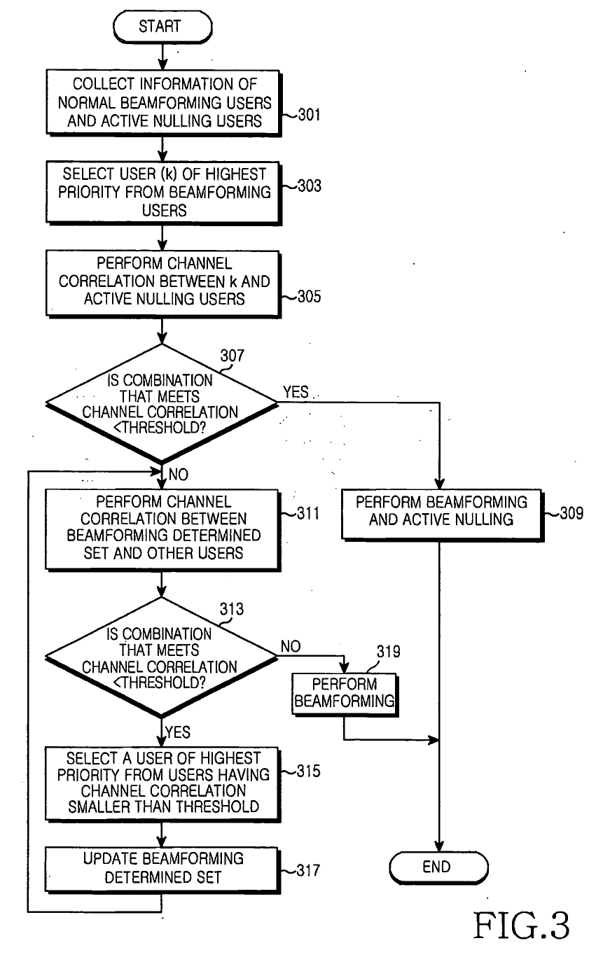

FIG. 3 illustrates a scheduling procedure in consideration of both the active nulling user and the beamforming user in a smart antenna system according to an exemplary embodiment of the present invention. For example, FIG. 3 outlines an algorithm to determine users to be serviced at the same time with respect to the same resource to minimize the performance degradation of a user for which the active nulling is to be conducted by the base station. In the following explanation, it is assumed that the number of users for the normal beamforming execution is M and the number of users for the active nulling execution is N.

Referring to FIG. 3, the base station gathers channel information of the users for the normal beamforming execution and channel information of the users for the active nulling execution at step 301. Herein, the channel information is a channel estimation value.

After collecting the channel information of every user (the user for the beamforming execution and the user for the active nulling execution), the base station selects one user of the highest priority from the normal beamforming users at step 303. For instance, one user with the maximum PF (hereafter, referred to as a k-th user) is selected using the PF algorithm. The PF algorithm can be defined as Equation 3 below.

$${PF}_{i} ( t ) = \frac{{R}_{i} ( t )}{{\overline{R}}_{i} ( t )} for all i ( i = 1 , 2 , … , M ) \\ k = {arq max}_{k = 1 , … , M} \{ {PF}_{1} ( t ) , {PF}_{2} ( t ) , … , {PF}_{M} ( t ) \} \qquad [ Equation 3 ]$$

In Equation 3, Rᵢ(t) denotes required data amount of the user i at time t, and R̅ᵢ(t) denotes average data amount in use of the user i at the time t. In other words, a user who used the great resource before to adjust the resource allocation ratio exhibits the low PF.

Next, the base station generates channel combinations of the k-th user and the active nulling users, respectively, and calculates channel correlation values of the channel combinations as defined in Equation 4, at step 305. In detail, the base station calculates a channel correlation between the k-th user (the selected beamforming user) and the active nulling users, respectively.
pᵢ=hₖ\textcircled{×}hⱼ for all j(j=1, 2, . . . , N) [Equation 4]

In Equation 4, hₖ denotes the channel of the k-th user and hⱼ denotes the channel of a j-th user amongst the active nulling users.

After calculating the channel correlation values between the active nulling users and the k-th user, the base station compares the calculated channel correlation values with a preset threshold at step 307.

If there are channel correlation values smaller than the threshold, the base station determines the beamforming for the k-th user and the active nulling beamforming for the active nulling users corresponding to the channel correlation values smaller than the threshold at step 309, and then terminates the algorithm.

By contrast, if there are no channel correlation values smaller than the threshold, the base station calculates channel correlation between users selected from the beamforming users (hereafter, referred to as a beamforming determined set) and the other users at step 311. Fundamentally, to provide service without mutual interference, the channel correlation should be low between the users selected for the beamforming. Hence, channel correlation values are calculated between the users belonging to the beamforming determined set and a user selected on the basis of a certain criterion (the sequential selection), and the greatest value is stored as a channel correlation value between the selected user and the beamforming determined set. By repeating this operation, the greatest channel correlation value is calculated with respect to other users. If the base station proceeds to step 311 from step 307, the number of the users constituting the beamforming determined set becomes one (the k-th user).

As described above, after calculating the channel correlation values with the beamforming determined set for the other users, the base station compares the calculated channel correlation values with a preset threshold at step 313.

If there are channel correlation values smaller than the threshold, the base station selects a user of the highest priority from the users corresponding to the channel correlation values smaller than the threshold at step 315. As aforementioned, the user of the highest priority can be selected using the PF algorithm.

Next, the base station includes the selected user into the beamforming determined set at step 317. The base station returns to step 311 and resumes the subsequent steps.

By contrast, if there are no channel correlation values smaller than the threshold at step 313, the base station determines the beamforming for the users belonging to the beamforming determined set at step 319 and then terminates the algorithm.

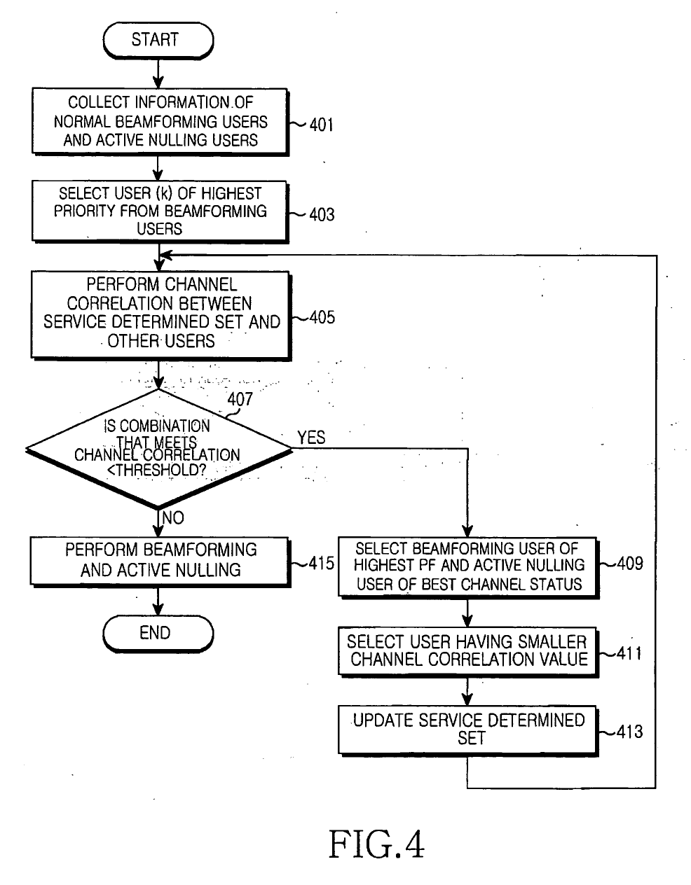

FIG. 4 illustrates a scheduling procedure which takes count of both an active nulling user and a beamforming user in the smart antenna system according to an exemplary embodiment of the present invention. For example, FIG. 4 outlines the algorithm to determine users to be serviced at the same time using the same resource in consideration of the active nulling users and the normal beamforming users all together. In the following explanation, it is assumed that the number of the normal beamforming users is M and the number of the active nulling users is N.

Referring to FIG. 4, the base station collects channel information of the normal beamforming users and channel information of the active nulling users at step 401. Herein, the channel information is a channel estimation value.

After gathering the channel information of all users (the beamforming users and the active nulling users), the base station selects one user of the highest priority from the normal beamforming users at step 403. For instance, the base station can select the user of the highest priority using the PF algorithm. In doing so, a “service determined set” is constituted with the selected user.

Next, the base station calculates channel correlations between the users constructing the service determined set and the other unselected users (including the beamforming users and the active nulling users) at step 405. Fundamentally, the service can be provided without the mutual interference when the channel correlation is low between the users belonging to the service determined set. Thus, channel correlation values are calculated between the users belonging to the service determined set and a user selected from the other unselected users on the basis of a certain criterion (sequential selection), and the greatest value is stored as a channel correlation value of the selected user and the service determined set. By repeating this operation, channel correlation values with the service determined set are calculated with respect to other users. If the base station proceeds right to step 405 from step 403, the number of the users constituting the service determined set is one.

As mentioned above, after calculating the channel correlation values with the service determined set for the other users, the base station compares the calculated channel correlation values with a preset threshold, respectively, at step 407.

If there are channel correlation values smaller than the threshold, the base station classifies the users corresponding to the channel correlation values smaller than the threshold to beamforming users and active nulling users at step 409. The base station selects a user of the highest PF (referred to as a first user) from the classified beamforming users and selects a user of the best channel status (referred to as a second user) from the classified active nulling users.

Next, at step 411, the base station selects either the first user or the second user, who has the smaller channel correlation value calculated at step 405. At step 413, the base station includes the selected user into the service determined set. At this time, the user included into the service determined set may be the beamforming user or the active nulling user. Next, the base station returns to step 405 and resumes the subsequent steps.

In the mean time, if there are no channel correlation values smaller than the threshold at step 407, the base station determines the service for the users belonging to the service determined set at step 415. In other words, the base station determines the active nulling beamforming to the active nulling users and determines the beamforming to the beamforming users amongst the users of the service determined set, and then terminates the algorithm.

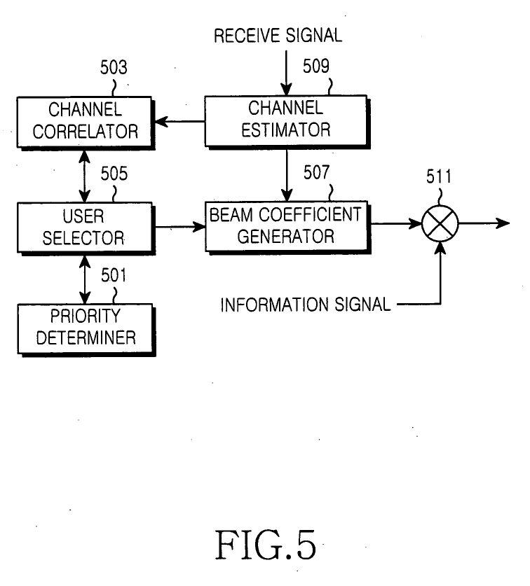

FIG. 5 is a block diagram of the base station in the smart antenna system according to an exemplary embodiment of the present invention.

As shown in FIG. 5, the base station includes a priority determiner 501, a channel correlator 503, a user selector 505, a beam coefficient generator 507, a channel estimator 509, and a multiplier 511.

Referring to FIG. 5, the user selector 505 selects users to be serviced at the same time with respect to the same resource based on the algorithm of FIG. 3 or the algorithm of FIG. 4. At this time, the selected users include the beamforming user and the active nulling user.

In the algorithm of FIG. 3 or FIG. 4, when the channel correlation operation is needed, the user selector 505 provides the channel correlator 503 with user combinations requiring the channel correlation and acquires the corresponding channel correlation values from the channel correlator 503. Also, in the algorithm of FIG. 3 or FIG. 4, when the user selection based on the PF algorithm is required, the user selector 505 provides the priority determiner 501 with the set of users for the PF algorithm execution and receives a user selected based on the PF algorithm from the priority determiner 501.

The channel estimator 509 estimates the channel of each terminal using the signal received from each terminal. The channel correlator 503 receives the channel estimation value of each terminal from the channel estimator 509, performs the channel correlation according to the request of the user selector 505, and provides the result to the user selector 505. The priority determiner 501 executes the PF algorithm according to the request of the user selector 505 and provides the result to the user selector 505.

When the users to be serviced are finally selected by executing the algorithm of FIG. 3 or FIG. 4, the user selector 505 issues a user selection signal to the beam coefficient generator 507.

The beam coefficient generator 507 generates beam coefficients to be applied to the corresponding users, respectively, according to the user selection signal from the user selector 505. In doing so, the beam coefficient generator 507 can generate the beam coefficients using the channel estimation values from the channel estimator 509. The beam coefficient generator 507 generates a normal beam coefficient for the beamforming user and an active nulling beam coefficient for the active nulling user. The generated beam coefficient is fed to the multiplier 511.

The multiplier 511 multiplies the beam coefficient from the beam coefficient generator 507 by a user information signal to be transmitted and outputs the product. That is, the multiplier 511 serves to generate the beam for the signal transmitted to each terminal. The signal output from the multiplier 511 passes through a baseband signal processing (for example, IFFT operation), undergoes Digital to Analog Converter (DAC) process and Radio Frequency (RF) processing, and then is transmitted on an antenna.

As set forth above, by scheduling to enhance the reception performance of the terminal by eliminating the interference of the adjacent base station affecting the reception performance of the terminal in the smart antenna system, it is possible to prevent the communication interruption when the terminal is placed in the cell boundary and the C/I falls below a specific level. For example, in the system where the normal beamforming users and the active nulling users are mingled, the present invention suggests the criterion to select the users that do not interfere with one another for the same resource, to thereby efficiently utilize the resource.

Exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, function programs, codes, and code segments for accomplishing the present invention can be easily construed as within the scope of the invention by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A transmission method in a smart antenna system, the method comprising:
selecting at least one user of a normal beamforming corresponding to a certain criterion;
selecting an active nulling user comprising a low channel correlation with the selected beamforming user from users of an active nulling; and
determining the normal beamforming for the selected beamforming user and the active nulling beamforming for the selected active nulling user.

2. The transmission method of claim 1, wherein the certain criterion comprises at least one of a proportional fairness (PF) selection algorithm and a round robin selection algorithm.

3. The transmission method of claim 1, wherein the selecting of the active nulling user comprises:
calculating channel correlation values between the selected beamforming user and the users of the active nulling;
comparing the calculated channel correlation values with a threshold; and
selecting an active nulling user corresponding to a channel correlation value smaller than the threshold.

4. The transmission method of claim 3, wherein the calculating of the channel correlation value comprises:
collecting channel values of the users of the normal beamforming and the users of the active nulling; and
correlating the channel value of the selected user to the channel values of the users of the active-nulling.

5. The transmission method of claim 1, further comprising:
constituting a beamforming determined set by selecting users comprising low channel correlation from the users of the beamforming when the active nulling user comprising the low channel correlation is not found; and
determining the normal beamforming for users comprised in the beamforming determined set.

6. The transmission method of claim 5, wherein the constituting of the beamforming determined set comprises:
calculating channel correlation values with the beamforming determined set corresponding to other users not comprised in the beamforming determined set;
comparing the calculated channel correlation values with a threshold;
when there are channel correlation values smaller than the threshold, selecting at least one user comprising a highest priority from corresponding users, including the selected user into the beamforming determined set, and feeding back to the calculating of the channel correlation value corresponding to the beamforming determined set; and
terminating the constituting of the beamforming determined set when channel correlation values are not smaller than the threshold.

7. The transmission method of claim 5, wherein initial construction of the beamforming determined set comprises at least a user selected from the users of the normal beamforming corresponding to a certain criterion.

8. The transmission method of claim 5, wherein the calculating of the channel correlation value with the beamforming determined set comprises:
sequentially selecting other users;
calculating channel correlation values between the selected user and the users comprised in the beamforming determined set; and
determining a maximum value of the calculated channel correlation values as a channel correlation value between the selected user and the beamforming determined set.

9. The transmission method of claim 1, further comprising:
generating a beam coefficient to be applied to the user of the determined execution of the normal beamforming and a beam coefficient to be applied to the user of the determined execution of the active nulling beamforming; and
forming a beam by multiplying the generated beam coefficients by corresponding user signals.

10. The transmission method of claim 1, further comprising providing a service to the selected beamforming user and the selected active nulling user using the same resource at the same time.

11. A transmission method in a smart antenna system, the method comprising:
constituting a service determined set by selecting users comprising a low channel correlation from users of a normal beamforming and users of an active nulling; and
determining the normal beamforming for a beamforming user and the active nulling beamforming for an active nulling user from the users comprised in the service determined set.

12. The transmission method of claim 11, wherein the constituting of the service determined set comprises:
calculating channel correlation values with the service determined set corresponding to other users not comprised in the service determined set;
comparing the calculated channel correlation values with a threshold;
when there are channel correlation values smaller than the threshold, selecting one user of the highest priority from corresponding users, including the selected user of the service determined set, and feeding back to the calculation of the channel correlation value calculating in relation to the service determined set; and
terminating the constituting of the service determined set when the channel correlation values smaller than the threshold are not found.

13. The transmission method of claim 12, wherein initial construction of the service determined set comprises at least one user selected from the users of the normal beamforming corresponding to a certain criterion.

14. The transmission method of claim 13, wherein the certain criterion comprises at least one of a proportional fairness (PF) selection algorithm and a round robin selection algorithm.

15. The transmission method of claim 12, wherein the calculating of the channel correlation value in relation to the service determined set comprises:
sequentially selecting other users;
calculating channel correlation values between the selected user and the users comprised in the service determined set; and
determining a maximum value of the calculated channel correlation values as a channel correlation value between the selected user and the service determined set.

16. The transmission method of claim 12, wherein the feeding back comprises:
when there are channel correlation values smaller than the threshold, classifying corresponding users to beamforming users and active nulling users;
selecting a user comprising the highest priority (a first user) from the classified beamforming users;
selecting a user comprising the best channel status (a second user) from the classified active nulling users;
selecting at least one of the first user and the second user comprising a smaller channel correlation value with the service determined set; and
including the selected user of the service determined set and feeding back to the calculation of the channel correlation in relation to the service determined set.

17. The transmission method of claim 11, further comprising:
providing a service to the users comprised in the service determined set using the same resource at the same time.

18. A base station in a smart antenna system, comprising:
a user selector for selecting at least one user of a normal beamforming corresponding to a certain criterion, and selecting an active nulling user comprising a low channel correlation with the selected beamforming user from users of an active nulling to be conducted;
a beam coefficient generator for generating beam coefficients for the selected beamforming user and the selected active nulling user; and
a multiplier for forming a beam by multiplying the beam coefficients from the beam coefficient generator by corresponding user signals.

19. The base station of claim 18, wherein the certain criterion comprises a proportional fairness (PF) selection algorithm and a round robin selection algorithm.

20. The base station of claim 18, further comprising a channel estimator for estimating a channel value of the users of the normal beaming is to be conducted and the users of the active nulling.

21. The base station of claim 20, wherein the user selector calculates channel correlation values between the selected beamforming user and the users of the active nulling, compares the calculated channel correlation values with a threshold, and selects an active nulling user corresponding to a channel correlation value smaller than the threshold.

22. The base station of claim 20, wherein the beam coefficient generator generates the beam coefficient using the channel estimation value from the channel estimator.

23. The base station of claim 18, wherein when the active nulling user does not comprise the low channel correlation, the user selector selects users comprising the low channel correlation from the users of the beamforming and issues the user selection information to the beam coefficient generator.

24. A base station in a smart antenna system, comprising:
a user selector for forming a service determined set by selecting users comprising a lower channel correlation from users of a normal beamforming and users of an active nulling;
a beam coefficient generator for generating beam coefficients for users comprised in the service determined set; and
a multiplier for forming a beam by multiplying the beam coefficients from the beam coefficient generator by corresponding user signals.

25. The base station of claim 24, further comprising:
a channel estimator for estimating channel values of the users of the normal beamforming and the users of the active nulling.

26. The base station of claim 25, wherein the beam coefficient generator generates the beam coefficients using the channel estimation values from the channel estimator.

27. The base station of claim 24, wherein the user selector calculates channel correlation values with the service determined set corresponding to users not comprised in the service determined set, compares the calculated channel correlation values with a threshold, and updates the service determined set when there are channel correlation values smaller than the threshold.

28. The transmission method of claim 1, further comprising forming a service determined set by selecting users comprising the low channel correlation from users of the normal beamforming and users of the active nulling.

29. The transmission method of claim 28, further comprising updating the service determined set when channel correlation values are smaller than a threshold.

30. The base station of claim 18, wherein the user selector forms a service determined set by selecting users comprising the low channel correlation from users of the normal beamforming and users of the active nulling.

31. The base station of claim 30, where the user selector updates the service determined set when channel correlation values are smaller than a threshold.

32. A computer-readable medium storing a computer program for selecting a user in a system that enhances reception performance of a terminal wherein a user for which active nulling is employed and a user for which the normal beamforming is employed are mingled, the computer program comprising a first set of instructions for scheduling a user to be serviced by eliminating the interference of an adjacent base station through comparison of both a user serviced by a current base station and at least one user for which active nulling is requested from the adjacent base station.

33. A computer-readable medium as claimed in claim 32, further comprising a second set of instructions for selecting a user of the highest priority from a group of normal beamforming users.

34. A computer-readable medium as claimed in claim 33, wherein the second set of instructions comprises using a Proportional Fairness (PF) scheduling algorithm to select a user with maximum PF.

35. A computer-readable medium as claimed in claim 32, further comprising a second set of instructions for selecting a user using a Round Robin scheme.
